(19) United States
(12) Patent Application Publication
(10) Pub. No.: US 2010/0257974 A1
(43) Pub. Date: Oct. 14, 2010

(54) Mechanical machine designed to utilize unbalanced torque to enhance angular momentum

(76) Inventor: Vernon M. Carrens, Mountain Home, AR (US)

Correspondence Address: VERNON M. CARRENS, P.O. BOX 842, MOUNTAIN HOME, AR, 72654, US

(21) Appl. No.: 11/731,076

(22) Filed: Mar. 29, 2007

Related U.S. Application Data
(60) Provisional application No. 60/815,632, filed on Jun. 21, 2006.

(51) Int. Cl. F16F 15/31

(52) U.S. Cl. 74/572.11

(57) ABSTRACT

A uniquely designed mechanical mechanism integrated with an off set type flywheel that requires minimum energy input to enhance sustained maximum output. Revolving and oscillating spherical units, relevant to the machine's center of gravity, produces an unbalanced torque to the machine's rotor. The rotor will therefore rotate with minimal energy input and will sustain average angular velocity, independent of an external power source, for a longer period of time than a traditional flywheel of like mass. The unbalanced torque is produced by changing the positions of the spheres relevant to the machine's center of gravity. This is done by the use of a stationary power track, one-half shaped as a semicircle with the other half shaped as a parabola. In this stationary track, which is rigidly incorporated with the mounting bracket and the rotor's axel, there are installed yo-yo shaped casters that are connected to the spheres by use of connecting support rods. These connecting support rods pass through linear bearings which are housed in portals of the rotor's off-set. Due to the rotation of the rotor the connecting support rods force the yo-yo shaped casters to follow the power track thus creating a revolving and oscillating effect on the spherical units in reference to the machine's center of gravity. Keep in mind that the mass of the rotor is in perfect balance but the force exerted on it by the power stroke assembly unit cause it to experience unstable equilibrium thus sustaining rotation and angular momentum.

### CROSS-REFERENCE TO RELATED APPLICATIONS

I claim the benefit of my previous filed provisional patent: Application Number (60/815,632), Filing Date (Jun. 21, 2006), Name Of Applicant (Vernon Mock Carrens), Title Of Invention (Zeke's Flywheel)

### BACKGROUND OF THE INVENTION

1) Field of the Invention

The field of this invention relates to an energy saving device that can be utilized with wheels, motors, generators, pumps, and rotating machines that do work while under the influence of gravity and centrifugal force. This machine incorporates an intricate flywheel design that utilizes unbalanced torque to enhance energy transfer through angular momentum. The present invention, being more energy efficient, will therefore rotate with minimal energy input and will sustain motion independent of an external energy source for a longer time span than a traditional type flywheel of like mass.

The scope of utilization is extensive; it can have a mass of several tons and be used in conjunction with atomic, wind, and hydro electric, generators. Supplementary power for irrigation pumps would be another use for this machine. It can be used in motor vehicles as a fuel saving device in combination with the engine or as a unique type momentum rim for tires. Transfer of power for smaller items such as clocks, toys, compressors, and small electric motors would make them more energy efficient when used in union with the present invention.

2) Description of the Prior Art

The concepts used in the physics of the flywheel and its use have been utilized for centuries being recorded as early as the 12th century. The function is to store kinetic energy in a rotating mass and use it as a continued or delayed pulsed power source, independent of the initial external power basis. Flywheel Energy Storage (FES) works by accelerating a rotor to a high speed and maintaining the energy in the system as rotational inertial energy. The life of the stored energy, being used, depends on the length of time of rotation and resistance exerted by the work load. Assuming that the work load is a constant, and the rotating length of time could be increased, then the flywheel would be more efficient and the quick charge time would be at a minimum.

A basic flywheel system consists of a rotor mass suspended by bearings and connected in some fashion, as with the use of gears, to a power source. On high speed and very efficient systems the bearings may be magnetic. The rotors are generally steel or of high-tensile-strength composite material such as a carbon fiber. Energy is stored in the rotor in proportion to its momentum, however, the amount of maximum energy storage is in direct proportion to the point when the rotor will warp or shatter.

### SUMMARY OF THE INVENTION

In relationship to my previously designed type of flywheel that requires minimum energy input to enable the enhancement of sustained energy for maximum output that's produced by an unbalanced torque. The torque is developed by an outer mass of oscillating and rotating segments, in respect to the machines center of gravity, which are guided by a stationary power track. Therefore, the advantage of the present invention is to extend the required energy level in revolutions per minute (rpm) for a flywheel (rotor) without requiring an additional external power source.

The objective of the present invention is to improve energy efficiency, of the flywheel, by extending a rotors normal operation time without having to add further external power input (to recharge). To give a hypothetical example: a traditional type flywheel (rotor), with (x) amount of mass, spinning at 4,000 rpm could release enough stored power to run a generator for 10 minutes, after which time its momentum would need to be recharged. In comparison: the present invention with the same amount of mass, spinning at 4,000 rpm could release the same amount of stored power for 12 minutes, thus being 20% more efficient.

The time gain, being in direct proportion to stored power, is created by the use of unbalanced torque which is exerted on the flywheel (rotor) by the mass of a series of rotating spheres that oscillate with respect to the machine's center of gravity. These spheres are guided by a uniquely designed power track that house and control yo-yo shaped casters. Connecting support rods are used to connect the yo-yo shaped casters to the spheres. These rods pass through linear bearings that are inserted in the portals of the rotors off-set and therefore are forced to move with the rotor. Portals have three functions: they allow the connecting rods to oscillate in respect to the rotor's center of gravity, while at the same time hold the yo-yo shaped casters in a set position as they travel around the track, and enable force from the unbalanced torque of the spherical mass to be transferred to the rotor.

The power track is designed in such a way as to control the yo-yo shaped casters attitude, thus keeping the spheres from spinning. The motion of the rotor causes the yo-yo shaped casters, located on the inner ends of the connecting rods, housed and being in accord with the stationary power track, to travel around the power track of which one half is a semicircle and the other half having an elliptical path. This motion in turn, due to the uniquely designed power track and accompanying yo-yo shaped casters, is transferred to the spheres which create the unbalanced torque on the rotor, reference to the machine's center of gravity.

### DESCRIPTION OF THE DRAWINGS

FIG. 1 is a shaded front view of a sustained energy apparatus embodying the present invention that shows the direction of rotation, rotor, power transfer gear, bearings, axel, and the eight spheres partially hidden by the rotor, that are in a particular given position of the moment.

FIG. 2 is a shaded transparent front view of the rotor showing the direction of rotation, spheres, linear bearings installed in the portals of the rotor's off-set, power track's left side (semicircle) and right side (parabola).

FIG. 3 is a shade side view with front of the machine facing right, showing the transparent off-set rotor, rotor bearings, spheres, front and back sides of the power track with attached axel and mounting bracket.

FIG. 4 is an exploded angular side view showing the complete machine, starting from left to right; a solid one piece unit consisting of the mounting bracket the back half of the power track and axel, spheres, linear bearings, connecting support rods, yo-yo shaped casters, power track assembly bolts, front half of power track, rotor bearings, rotor with connecting support rod bearing ports, and the power transfer gear.

FIG. 5 is a enlarged front view of one of eight identical power stroke assembly units that consist of a; sphere, connecting support rod, linear bearing, with exploded yo-yo shaped caster and yo-yo caster bearings. The number of these identical units may vary in a given machine depending on size and type of work required.

FIG. 6 is a separated view of the two sides of the power track showing attitude of two power stroke assembly units, one with the yo-yo bearing exposed, and the three power track connecting bolts.

FIG. 7 is a front view of the eight power stroke assembly units, the left and right sides of the back half of the power track, the yo-yo casters attitude to the power track, and direction of rotation.

### DETAILED DESCRIPTION OF THE INVENTION

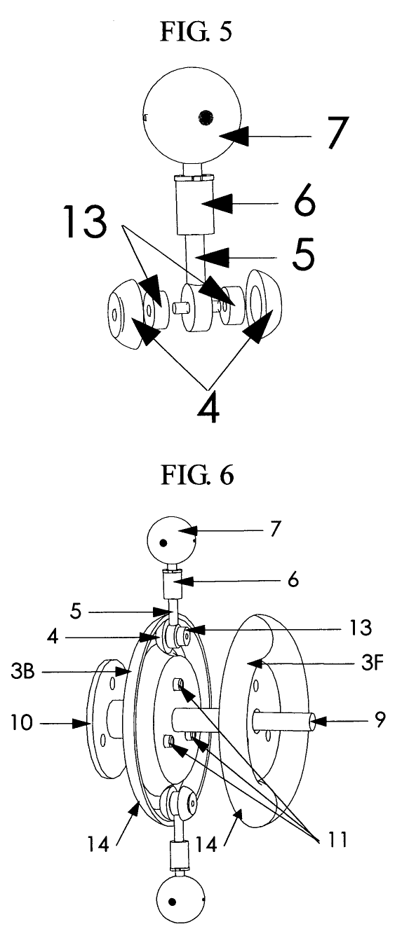

An integrated system designed to require minimum energy input to enable sustained maximum output by utilizing the motion of spherical masses to create a constant unbalanced torque. Once the machine is put in motion by an external power source through the use of the power transfer gear 2, the rotor 1, will reach a predetermined rpm. As the rotor 1, spins it will force the power stroke assembly units FIG. 5, to move in orbit around the machine's center of gravity at the axel 9. This motion is due to the force exerted, by the rotor 1, on the support rods 5, through the linear bearings 6. This motion will also cause the yo-yo casters 4, to follow the power track 3, in doing so the spheres 7, will react accordingly and follow a circular path on the left side of the rotor 1, created by the left side of the power track 3L, and a parabolic path on the right side of the rotor 1, created by the right side of the power track 3R. As the spheres 7, follow the parabolic path on the right side of the rotor 1, they move farther away from the center of gravity at the axel 9, than their counter part on the left side. This creates a lever which produces torque. This continuous torque is exerted on the rotor 1, by the support rods 5, through the linear bearings 6, thus exerting angular momentum to the rotor 1.

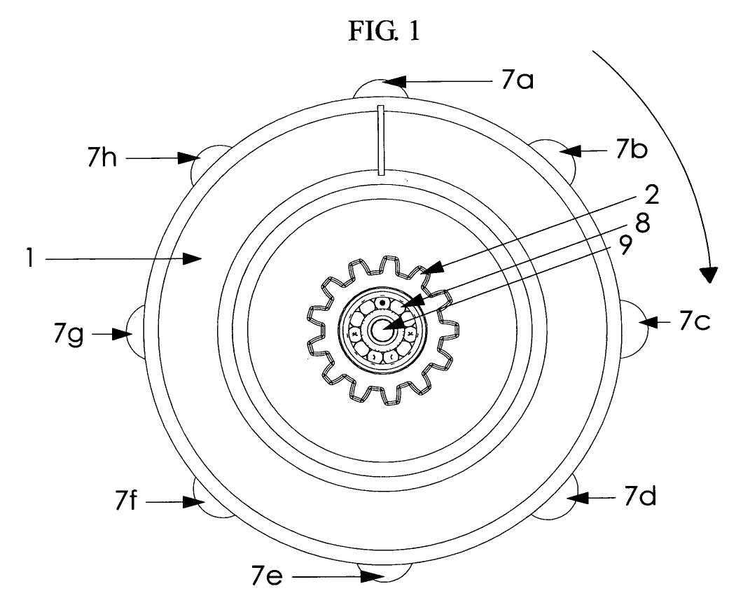

Referring to FIG. 1 of the drawings shows the front view with a clockwise direction of rotation, rotor mass 1, power transfer gear 2, rotor bearings 8, axel 9, eight spherical mass units (7-a through 7-h).

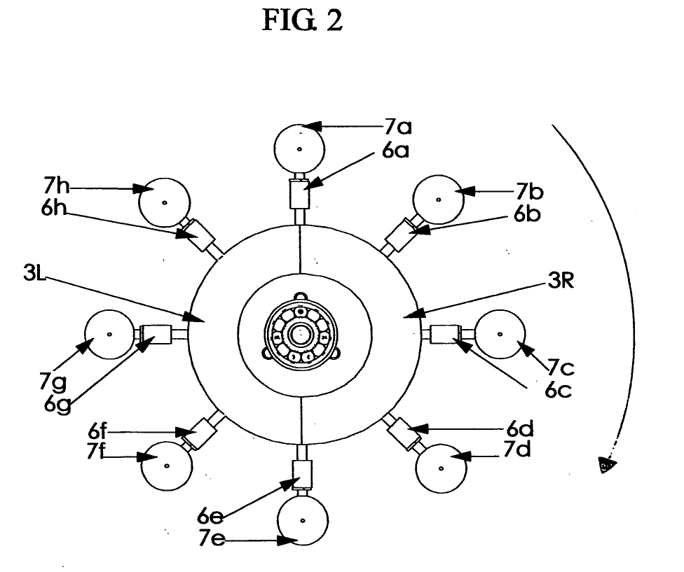

Referring to FIG. 2, shows a front view of the transparent rotor 1 with direction of rotation, view of the linear bearings housed in the portals of the rotor 6-a, 6-b, 6-c, 6-d, 6-e, 6-f, 6-g, 6-h, spherical mass units 7-a, 7-b, 7-c, 7-d, 7-e, 7-f, 7-g, 7-h, power track's left 3L-B and right 3R-B halves.

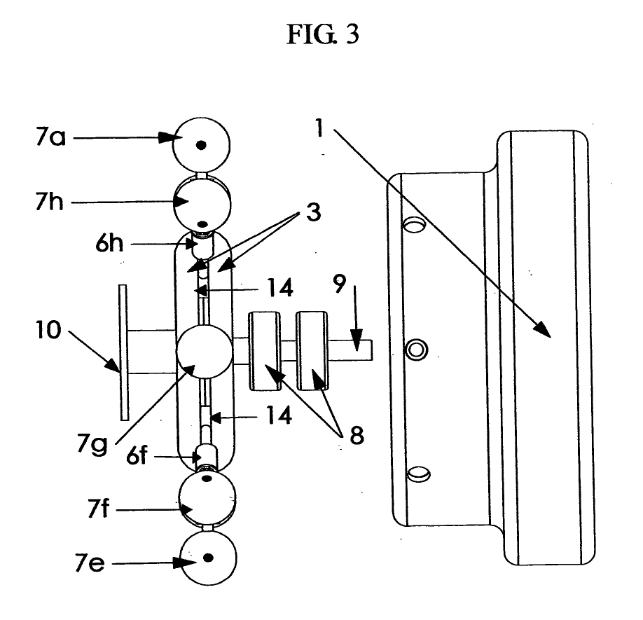

Referring to FIG. 3, shows a transparent shaded side view of the off set designed rotor 1, with the front facing to the right, axel 9, rotor bearings 8, the mounting bracket 10, both sides of the power track 3, spherical mass units 7-a, 7-h, 7-g, 7-f, 7-e.

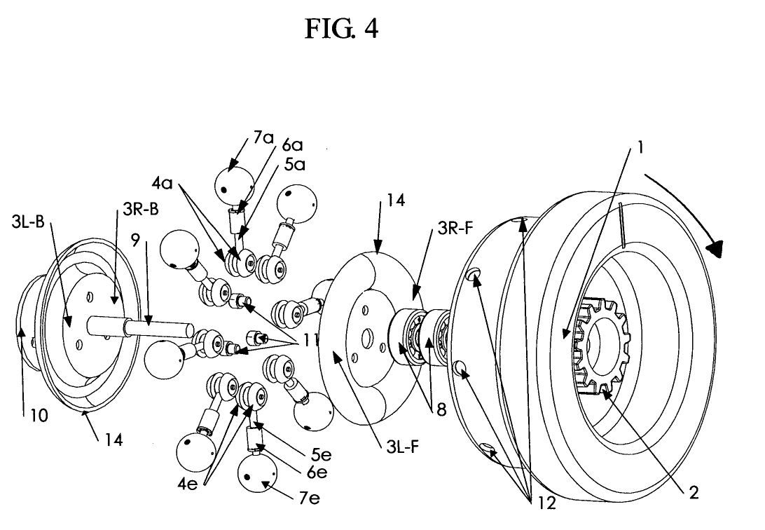

Referring to FIG. 4, shows an exploded view of the complete machine from left to right, mounting bracket 10, back left side of the power track 3L-B, back right side of the power track 3R-B, axel 9, spherical mass unit 7a, linear bearing unit 6a, connecting support rod unit 5a, yo-yo caster unit 4a, power track connecting bolts 11, front left side of the power track 3L-F, front right side of the power track 3R-F, rotor bearings 8, connecting support rod portals 12, power transfer gear 2, rotor mass 1.

Referring to FIG. 5, shows the power stroke assembly unit consisting of the sphere 7, linear bearing 6, connecting support rod 5, and exploded view of yo-yo casters 4, and yo-yo casters bearings 4b.

Referring to FIG. 6, shows the mounting bracket 10, back side of the power track 3B, power stroke assembly unit consisting of sphere 7, connecting support rod 5, one half yo-yo caster on left side 4, other half of yo-yo caster on right side removed in order to view yo-yo caster bearing 4b, linear bearing 6, power track connecting bolts 11, disjointed front side of power track 3F, rotor's axel 9.

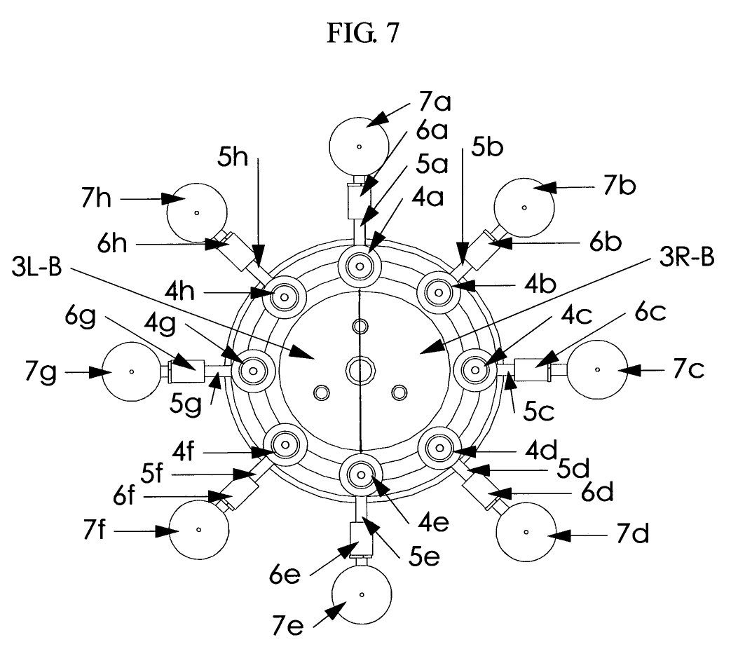

Referring to FIG. 7, indicates the direction of rotation and shows the back half of the power track with the left half 3L-B, being a perfect circle and the right half 3R-B, being a parabola, spheres 7a through 7h, linear bearings 6a through 6h, support rods 5a through 5h, yo-yo casters 4a through 4h, and the yo-yo caster's attitude in respect to the power track.

1-5. (canceled)

6. A flywheel comprising:
a rotor mounted on at least one rotor bearing for rotational motion, said rotor having an off-set and a plurality of portals disposed about a periphery of said off-set and further having a linear bearing mounted in each of said plurality of portals;
a stationary power track, said power track comprising a front side having a circumference and a back side having a circumference, wherein said back side is spaced apart from said front side along the entirety of said circumferences;
said front side of said power track comprising a front left half and a front right half, said back side of said power track comprising a back left half and a back right half;
wherein said front left half and said back left half comprise a semicircular track and wherein said front right half and said back right half comprise a parabolic track;
a plurality of power stroke assembly units;
wherein each of said power stroke assembly units is associated with a respective one of said portals, wherein each of said power stroke assembly units comprises a connecting support rod, a spherical mass on an outward end of said connecting support rod and a rotatably mounted yo-yo caster on an inward end of said connecting support rod and wherein each of said power stroke assembly units is disposed such that each connecting support rod passes between said spaced apart circumferences of said front side and said back side and is slidably received in a respective linear bearing and each rotatably mounted yo-yo caster contacts said power track.

7. The flywheel of claim 6 wherein said power track houses said yo-yo casters.

8. The flywheel of claim 6 wherein each of said front side and said back side of said power track is concave shaped in relation to said yo-yo casters.
